(19) United States
(12) Patent Application Publication
(10) Pub. No.: US 2017/0255772 A1
(43) Pub. Date: Sep. 7, 2017

(54) ELECTRONIC DEVICE AND A SCREEN UNLOCKING METHOD THEREOF

(71) Applicant: MediaTek Singapore Pte. Ltd., Singapore (SG)

(72) Inventor: Guoyang HU, Hefei City (CN)

(21) Appl. No.: 15/447,685

(22) Filed: Mar. 2, 2017

(30) Foreign Application Priority Data
Mar. 3, 2016 (CN) 201610126360.5

(51) Int. Cl. G06F 21/36; G06F 3/0488

(52) U.S. Cl. CPC G06F 21/36; G06F 3/04883

(57) ABSTRACT

The invention provides an electronic device and a screen unlocking method thereof. The method includes the steps that after a trace pattern generated by continuously sliding on a locked screen is obtained, detects whether the trace pattern contains at least one valid trace pattern which is predetermined; and when the at least one valid trace pattern is detected in the trace pattern, the locked screen is unlocked, wherein the trace pattern also contains at least one random invalid trace pattern. The screen unlocking method and electronic device can provide strong security for locked screen, and also significantly reduce unlocking times because of incorrect operation.

### CROSS REFERENCE TO RELATED APPLICATIONS

This application claims priority of China Patent Application No. 201610126360.5, filed on Mar. 3, 2016, the entirety of which is incorporated by reference herein.

### BACKGROUND OF THE INVENTION

Field of the Invention

The invention generally relates to screen unlocking technology, and more particularly, relates to an electronic device and a screen unlocking method thereof.

Description of the Related Art

Currently, electronic devices with applications have become increasingly popular, for example smartphones. Smartphones are increasingly used to protect user privacies, including account information, mobile payment information, mobile bank information, and so on. In order to protect smartphones from logining by strangers, users usually set a complex screen lock.

More and more users protect their devices by setting a more complex screen lock, which is cumbersome for the user when attempting to unlock the screen. On the other hand, since the user's screen lock has a fixed unlocking trace pattern, intruders will have more chances to learn and crack the screen lock.

In addition, the greater the electronic device screen size, the more frequent errors or incorrect operations occur when the user unlocks the screen. If several errors or incorrect operations occur consecutively, the screen unlocking may fail and system of the electronic device may be temporarily locked.

### BRIEF SUMMARY OF THE INVENTION

Accordingly, embodiments of the invention provide an electronic device and a screen unlocking method thereof to effectively solve the above problems.

In order to solve the above problems, one embodiment of the present invention provides a screen unlocking method, the screen unlocking method comprising: obtaining a trace pattern generated by continuously sliding on a locked screen; detecting whether the trace pattern contains at least one predetermined valid trace pattern; and when detecting the at least one predetermined valid trace pattern in the trace pattern, unlocking the locked screen, wherein the obtained trace pattern comprises at least one random invalid trace pattern.

In order to solve the above problems, another embodiment of the present invention provides an electronic device, wherein the electronic device comprises: a trace pattern obtaining module configured to obtain a trace pattern generated by continuously sliding on a locked screen; a trace pattern detection module configured to detect whether the trace pattern contains at least one predetermined valid trace pattern; and an unlocking module configured to unlock the locked screen when the trace pattern detection module detects the at least one predetermined valid trace pattern in the trace pattern, wherein the obtained trace pattern at least comprises random invalid trace pattern.

In order to solve the above problems, another embodiment of the present invention provides a screen unlocking method, comprising: obtaining a string generated by continuously inputting on a locked screen; detecting whether the string contains at least one predetermined valid string; and when detecting the at least one predetermined valid string in the string, unlocking the locked screen, wherein the obtained string comprises at least one random invalid string.

In order to solve the above problems, another embodiment of the present invention provides an electronic device, comprising: a string obtaining module configured to obtain a string generated by continuously inputting on a locked screen; a string detection module configured to detect whether the string contains at least one predetermined valid string; and an unlocking module configured to unlock the locked screen when the string detection module detects the at least one predetermined valid string in the string, wherein the obtained string at least comprises at least one random invalid string.

The beneficial effects of the embodiments are: compared with the situation of the prior art, the present invention can detect whether or not a trace pattern contains at least one predetermined valid trace pattern after obtaining the trace pattern generated by continuously sliding on the locked screen and as long as the trace pattern containing at least one predetermined valid trace pattern is detected, the locked screen can be unlocked. This will make it difficult for the intruder to crack the lock by viewing and learning, thus enhancing safety, effectively reducing the number of user unlocking errors, and improving the user experience.

### BRIEF DESCRIPTION OF DRAWINGS

The invention can be more fully understood by reading the subsequent detailed description and examples with references made to the accompanying drawings, wherein:

FIG. 1 is a flowchart of a screen unlocking method according to the first embodiment of the invention;

FIG. 2 is a schematic diagram illustrating an embodiment of a screen unlocking interface of FIG. 1;

FIG. 3 is a schematic diagram illustrating an embodiment of a predetermined valid trace pattern of FIG. 1;

FIG. 4 is a flowchart of a screen unlocking method according to the second embodiment of the invention;

FIG. 5 is a schematic diagram illustrating an embodiment of two trace pattern of FIG. 4;

FIG. 6 is a schematic diagram illustrating an embodiment of two predetermined valid trace pattern of FIG. 4;

FIG. 7 is a schematic diagram illustrating an embodiment of a trace pattern 5 of FIG. 4;

FIG. 8 is a schematic diagram illustrating an embodiment of a trace pattern 6 of FIG. 4;

FIG. 9 is a block diagram of an electronic device according to the first embodiment of the present invention;

FIG. 10 is a block diagram of an electronic device according to the second embodiment of the present invention;

FIG. 11 is a flowchart of a screen unlocking method according to the third embodiment of the invention;

FIG. 12 is a schematic diagram illustrating an embodiment of a screen unlocking interface of FIG. 11;

FIG. 13 is a flowchart of a screen unlocking method according to the fourth embodiment of the invention; and

FIG. 14 is a block diagram of an electronic device according to the third embodiment of the present invention.

### DETAILED DESCRIPTION OF THE INVENTION

The disclosure will now combine with the implementation of the accompanying drawings to fully describe clear examples of technical solutions of the present invention. It is clear that the described embodiments are merely part of the embodiments of the present invention, but not all embodiments. Based on the embodiments of the present invention, all other embodiments, of which the ordinary skilled in the art without creative efforts shall be made available, are within the scope of the present invention protected.

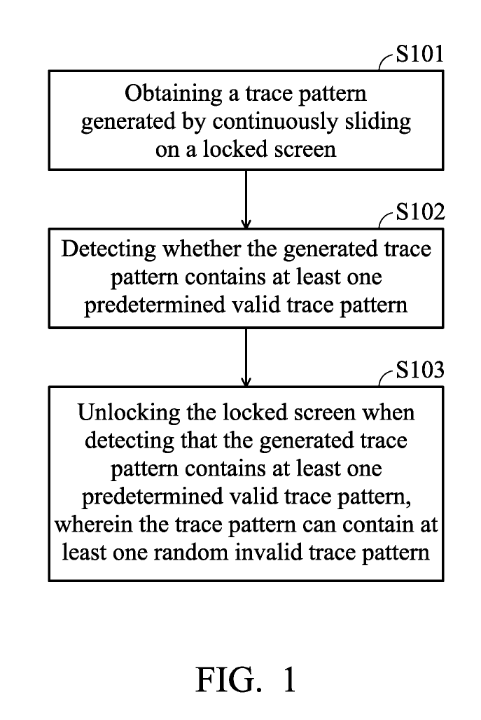

Please referring to FIG. 1, FIG. 1 is a flowchart of a screen unlocking method according to the first embodiment of the invention. As shown in FIG. 1, the screen unlocking method of the present embodiment can be performed by an electronic device. The electronic device provided by disclosed embodiments can be a mobile phone, a tablet computer, a personal digital assistant (PDA) or any other type of terminal device with a screen locking function. However, it is to be understood that the invention is not limited thereto. The screen unlocking method comprises the steps of:

S101: obtaining a trace pattern generated by continuously sliding on a locked screen;

Before step S101, the electronic device is in a sleep or standby mode, and the user may enable the electronic device to display a screen unlocking interface on a locked screen of the electronic device by pressing the power button or any function button capable of triggering a screen unlocking operation. In other embodiments of the present invention, the user can also wake up the electronic device by clicking on the screen.

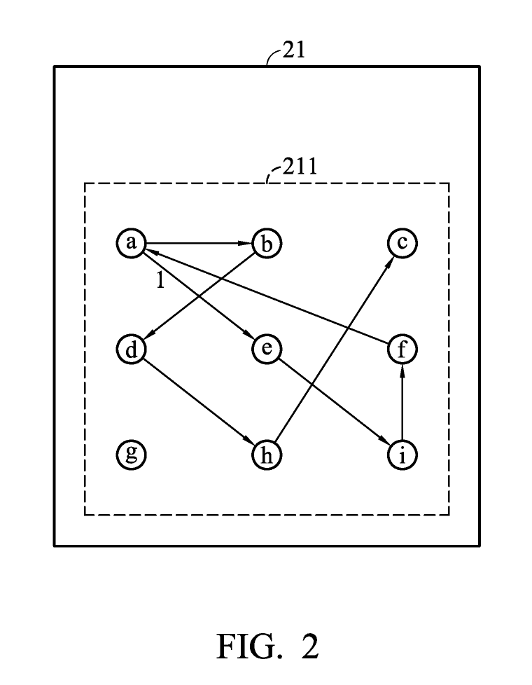

A nine-square-grid interface is used as an example of the screen unlocking interface for illustration purpose in this embodiment. As shown in FIG. 2, the screen unlocking interface 21 includes a nine-square-grid unlocking interface 211, each touch point in the nine-square-grid unlocking interface 211 has a corresponding code, e.g., the touch points a, b, c, d, e, f, g, h, i. A user may perform continuously sliding on the nine-square-grid unlocking interface 211 to pass through all of the touch points so as to generate a trace pattern, such as a trace pattern 1, which passes through the touch points in the following sequence: a-e-i-f-a-b-d-h-c. The electronic device receives the trace pattern generated by continuously sliding on the locked screen by the user.

S102: detecting whether the generated trace pattern contains at least one predetermined valid trace pattern;

After obtaining the trace pattern generated by continuously sliding on the locked screen, the electronic device detects whether the generated trace pattern contains at least one predetermined valid trace pattern. Specifically, the valid trace pattern refers to a trace pattern generated by continuously sliding on the respective touch points on the nine-square-grid interface by the user in advance based on a valid trace pattern setting function available on the electronic device. The user can preset one or more valid trace patterns.

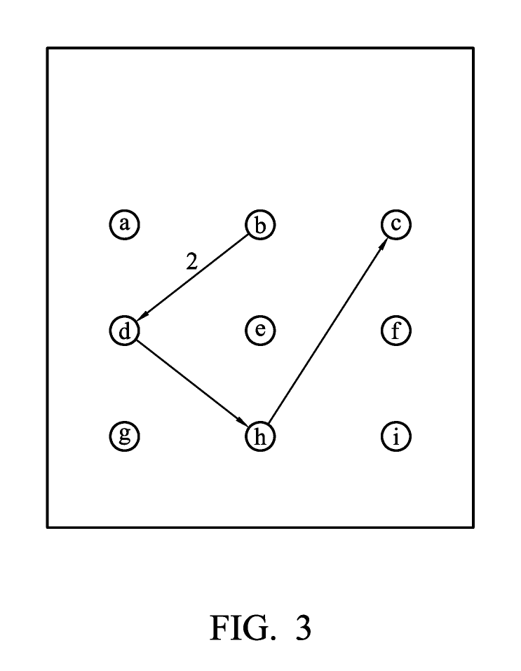

Taking the user presets a predetermined valid trace pattern 2 in below as an example, as shown in FIG. 3, the predetermined valid trace pattern 2 is b-d-h-c. At this step, the electronic device detects if the generated trace pattern 1 received at Step S101 contains the predetermined valid trace pattern 2.

S103 unlocking the locked screen when detecting that the generated trace pattern contains at least one predetermined valid trace pattern. The trace pattern can contain at least one random invalid trace pattern.

When the electronic device detects that the generated trace pattern contains at least one predetermined valid trace pattern, the electronic device unlocks the locked screen. For example, in this embodiment, the electronic device detects that the trace pattern 1 (a-e-i-f-a-b-d-h-c) contains the predetermined valid trace pattern 2 (b-d-h-c) and thus it unlocks the locked screen. Specifically, in this embodiment, the generated trace pattern which is used to unlock the screen should contain not only the valid trace pattern, but also random invalid trace pattern (above known as pseudo random unlocking pattern). Taking the trace pattern 1 as an example, the pseudo random unlocking pattern of which is a-e-i-f-a-b, and the pseudo random unlocking pattern contained in the trace pattern does not affect the screen unlocking operation. Additionally, every time the user performs the screen unlocking, the pseudo random unlocking pattern contained in the trace pattern does not have to be the same. For example, the trace pattern generated from the user's continuously sliding on the locked screen can be c-e-g-b-d-h-c, of which its pseudo random unlocking pattern is c-e-g-b. As long as the electronic device detects the valid trace pattern 2 in the trace pattern, the electronic device unlocks the locked screen. Therefore, for other people, since the user may set a complex pseudo random unlocking pattern on the unlocking screen, there is no way for the other people to know which part is the real valid trace pattern. Thus, it is difficult for the other people (e.g. other unauthorized users) to crack the lock through learning, thus enhancing safety.

In addition, in case where there is no other viewers, when an incorrect operation appears on the screen during the screen unlocking process, the user can still generate the correct valid trace pattern and achieve unlocking by continuously sliding on the screen. For example, when the continuously sliding on the locked screen for generating the trace pattern a-e-i-f-a-b is an incorrect operation, other sliding operation can be continued to generate another trace pattern containing the valid trace pattern b-d-h-c so as to achieve unlocking, thereby effectively reducing incorrect operation of the user during unlocking and improving user experience.

When the electronic device detects that the trace pattern does not contain at least one predetermined valid trace pattern, the electronic device keeps locking the screen. For example, when the trace pattern generated by the continuously sliding on the locked screen is a-e-i-f-a-b-d-h-i-f-c-f, and the electronic device detects that the trace pattern does not contain the predetermined valid trace pattern 2, the electronic device will keep locking the screen.

The embodiments of the present invention can detect whether the trace pattern contains at least one predetermined valid trace pattern after obtaining the trace pattern generated in response to continuously sliding on the locked screen and unlock the locked screen as long as the trace pattern is detected as containing at least one segment of predetermined valid trace pattern. This will make it difficult for the intruder to crack the lock through viewing and learning, thus enhancing safety, effectively reducing the number of user unlocking errors, and improving user experience.

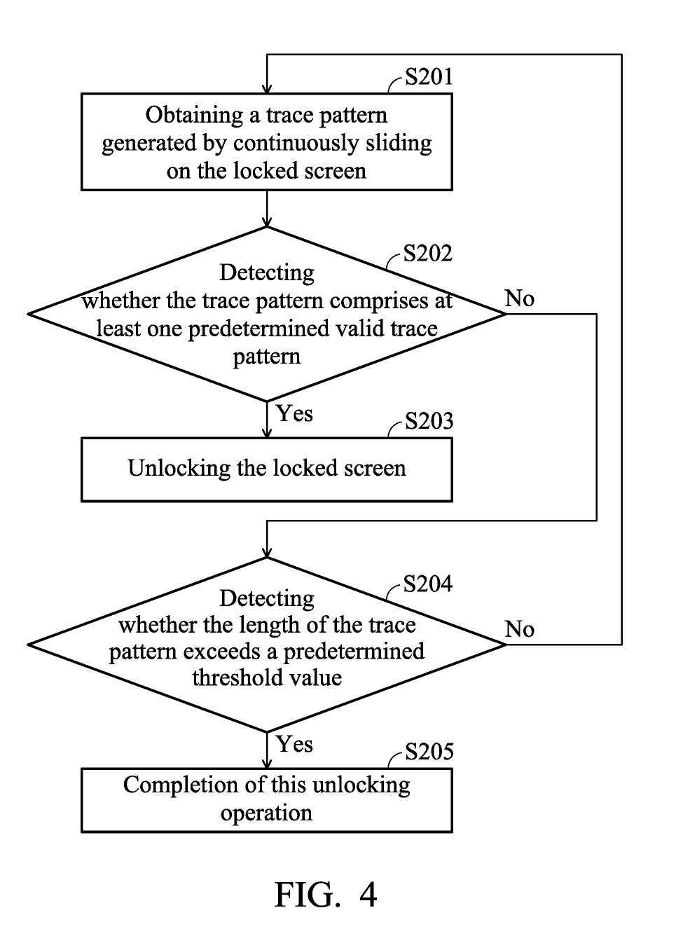

The present invention also provides a second embodiment of the screen unlocking method, which is described on the basis of the first embodiment of the screen unlocking method disclosed. FIG. 4 is a flowchart of a screen unlocking method according to the second embodiment of the invention. As shown in FIG. 4, the screen unlocking method of this embodiment comprises the steps of:

S201: obtaining a trace pattern generated by continuously sliding on the locked screen;

Specifically, in step S201 of this embodiment, when the electronic device detects the trace pattern is being interrupted, it does not immediately determines that this trace pattern is ended, and it further determines whether a continuous time for the interrupt trace less than a predetermined time value. When the electronic device detects the trace pattern is being interrupted, that is, when the electronic device detects that an interrupt occurs during the continuous sliding process performed by the user on the locked screen, it counts the continuous time for the interrupt occurred in the trace pattern. If yes, the electronic device regards the pattern and a pattern following the interrupt as a continuous trace pattern.

If the continuous time for which the trace pattern has been interrupted is greater than or equal to the predetermined time value, the electronic device determines that this sliding operation is ended, thereby directly accessing the trace pattern before the interrupt to be the generating trace pattern for this unlocking operation.

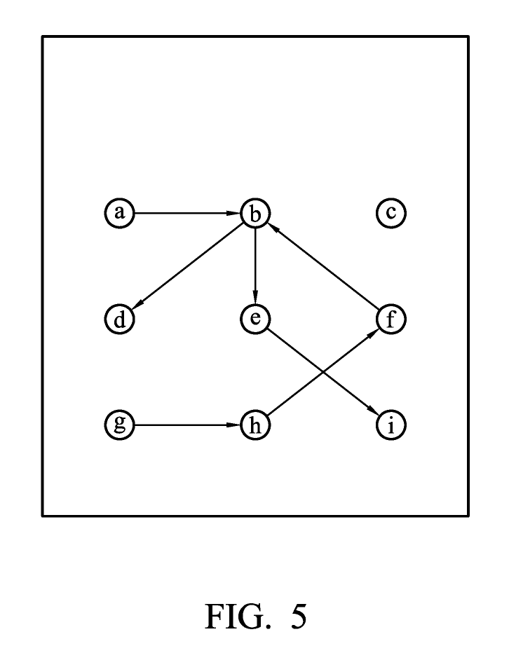

Referring to FIG. 5, assuming that there are two trace patterns, which are trace a-b-e-i and trace g-h-f-b-d, on the locked screen, if the time interval between the two trace patterns is less than a predetermined time value, the electronic device will regard these two trace pattern as a continuous trace pattern, namely a continuous trace pattern of a-b-e-i-g-h-f-b-d. If the time interval between the two trace patterns is equal to or greater than the predetermined time value, the electronic device determines that this sliding operations ended when detecting the interruption corresponding to the time interval between the two trace patterns, thereby directly accessing the trace pattern, i.e., a-b-e-i, to be the generating trace pattern for this unlocking operation.

In some embodiments, the predetermined time value is preferably to be 1 s (second). The predetermined time value may be set on the electronic devices by the user or it may be set at the factory during production.

S202, detecting whether the trace pattern comprises at least one predetermined valid trace pattern; if so, the flow goes to step S203; otherwise, goes to step S204.

Particularly, in this embodiment, the at least one predetermined valid trace pattern may be at least two or more predetermined valid trace patterns, and step S202 may comprise the step of the electronic device detecting whether the trace pattern sequentially contains the at least two or more predetermined valid trace patterns according to a predetermined order.

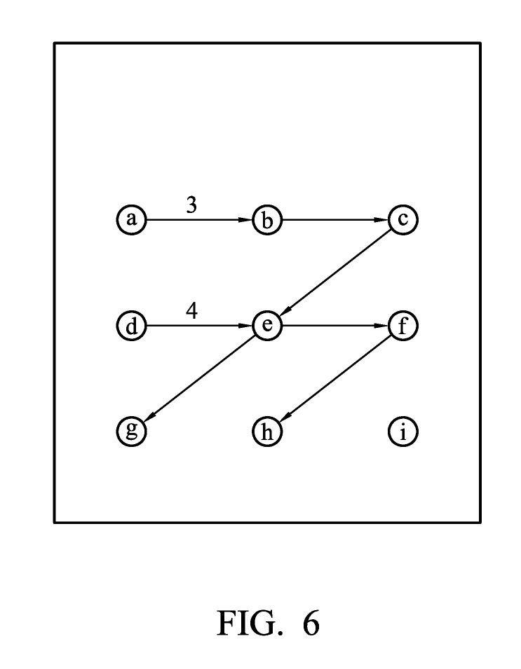

When the user sets at least two or more predetermined valid trace patterns, the user may sequentially set two valid trace patterns 3 and 4 on the nine-square-grid interface based on the valid trace pattern setting function provided on the electronic device. As shown in FIG. 6, the predetermined valid trace pattern 3 is a-b-c-e-g and the predetermined valid trace pattern 4 is d-e-f-h, wherein the predetermined order for the two predetermined valid trace patterns are: the predetermined valid trace pattern 3 at first and the predetermined valid trace pattern 4 later.

S203, unlocking the locked screen.

In step S203, when the electronic device detects that the generating trace pattern sequentially contains the at least two or more predetermined valid trace patterns according to the predetermined order, it unlocks the locked screen. In other words, when the electronic device detects that the generating trace pattern first contains the predetermined valid trace pattern 3, and then detects that the generating trace pattern contains the predetermined valid trace pattern 4, the electronic device unlocks the locked screen. The trace pattern may further comprise at least a random invalid trace pattern.

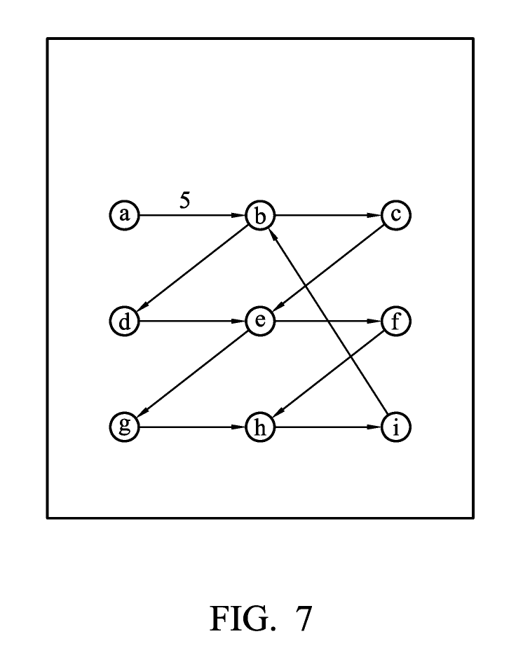

It is assumed that the trace pattern is to be the trace pattern 5 as shown in FIG. 7, wherein the trace pattern 5 is set to be a-b-c-e-g-h-i-b-d-e-f-h. As the trace patterns 5 sequentially contains the predetermined valid trace pattern 3 of a-b-c-e-g, a pseudo random unlocking pattern of g-h-i-b-d and the predetermined valid trace pattern 4 of d-e-f-h, so the electronic device unlocks the locked screen.

On the contrary, when the electronic device detects that the trace pattern does not sequentially contain the at least two or more predetermined valid trace patterns according to the predetermined order, the electronic device keeps locking the screen. That is, when the electronic device detects that the trace pattern does not sequentially contain the predetermined valid trace pattern 3 and the predetermined valid trace pattern 4, it will keep locking the screen.

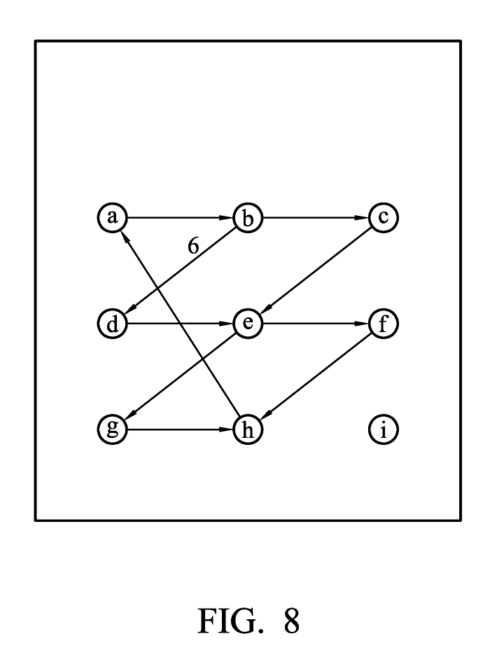

It is assumed that the trace pattern is to be the trace pattern 6 as shown in FIG. 8, wherein the trace pattern 6 is set to be b-d-e-f-h-a-b-c-e-g-h. As shown, the trace pattern 6 sequentially contains the predetermined valid trace pattern 4 of d-e-f-h, a pseudo random unlocking pattern of g-h and the predetermined valid trace pattern 3 of a-b-c-e-g. Due to the order of the predetermined valid trace pattern 3 and the predetermined valid trace pattern 4 does not match with the predetermined order, the screen unlocking operation is fail and the electronic device keeps locking the screen.

It should be understood that if there are at least two or more predetermined valid trace patterns, the electronic device may also unlock the locked screen when detecting that the trace pattern contains any of the valid trace patterns. In practice applications, the user can perform corresponding settings based on actual requirements.

S204, detecting whether the length of the trace pattern exceeds a predetermined threshold value; if so, the flow ends and jumps to step S205, and if not, the flow returns to step S201;

In this embodiment, when the electronic device detects that the trace pattern currently generated does not contain at least one predetermined valid trace pattern, it will subsequently detect whether updated trace pattern generated by continuously sliding on the screen by the user contains the valid trace pattern. Prior to this step, the method in this embodiment may also include step S204 for the electronic device to detect if trace pattern obtained exceeds the threshold value. Specifically, if the electronic device does not detect that the valid trace pattern is contained in the received trace pattern, the method of the embodiment may further detect whether the length of the trace pattern exceeds the threshold value. When the electronic device detects that the length of the trace pattern exceeds the threshold value, it determines this unlocking operation is completed, and the electronic device keeps locking the screen. When the electronic device detects that the length of the trace pattern has not exceeded the threshold value, it returns to step S201 to continue receive trace pattern that is newly generated.

Particularly, during the setting stage, the user can set the threshold value based on the threshold value setting function provided by the electronic device. Preferably, the trace pattern and the predetermined valid trace pattern are formed by connecting multiple valid touch points. For example, a-e-i-f-a-b-d-h-c of the trace pattern 1 is formed by nine connected valid touch points; b-d-h-c of valid trace pattern2 is formed by four connected valid touch points. Therefore, pseudo random unlocking pattern is also formed by connecting multiple valid touch points. For example, a-e-i-f-a-b of pseudo random unlocking pattern is formed by six connected valid touch points.

The threshold value can be a predetermined number (i.e. the number of predetermined valid touch points). The electronic device detects whether the length of the trace pattern exceeds the threshold value (i.e., the electronic device detects whether or not the number of valid touch points contained in the trace pattern exceeds the preset number).

In one embodiment, the predetermined number (threshold value) is 8. When the electronic device detects the number of valid touch points contained in the trace pattern1 is 9, which exceeds the predetermined number of 8, step S205 is entered such that the electronic device determines that this unlocking operation is completed and keeps locking the screen. In another embodiment, the predetermined number is 30. When the electronic device detects the number of valid touch points contained in the trace pattern 1 is 9, which does not exceed the predetermined number 30, it returns to step S201.

In some embodiments, the predetermined number can be five times of the total number of valid touch points contained in at least one predetermined valid trace pattern. For example, the total number of valid touch points contained in a valid trace pattern 2 is 4, the predetermined number can be set as 20.

In other embodiments, the valid trace pattern is multiple segments. Such as, the valid pattern includes three valid trace segments, the total number of valid touch points contained in the three valid trace segments are 4, 8, and 7 respectively, the maximum value of the total number of valid touch points obtained by the electronic device from the three segments of the valid trace pattern is 8, and the predetermined number is 40. That is, the predetermined number can be defaulted as five times of the maximum value of the total number of valid touch points contained in each of the predetermined valid trace segments. In addition, each of the valid trace segments of the valid pattern can be a separate valid pattern.

It should be noted that, the above threshold value can be specifically set as multiples of valid touch points or be directly set as a value based on the user's requirements, and the embodiments of the invention are not to be limiting.

It should be understood that, the present invention does not limit the sequence of steps executed. For example, this step of detecting whether the length of trace pattern exceeds the threshold value can be performed prior to the step of detecting whether the trace pattern contains valid trace pattern. Changing the sequence of execution will not affect the effect of the embodiments of the present invention in any way.

The predetermined numbers in this embodiment can prevent intruders from attempting to endlessly draw the trace pattern to unlock the locked screen, thus enhancing safety.

S205, this unlocking operation is completed.

According to the embodiments of the invention, whether at least one predetermined valid trace pattern contained in the trace pattern can be detected after the trace pattern generated in response to continuously sliding on the locked screen has been obtained and as long as the trace pattern containing at least one predetermined valid trace pattern is detected, the locked screen is unlocked. This will make it difficult for intruders to crack the lock by viewing and learning, thus enhancing safety, effectively reducing the user's unlocking errors, and improving user's experience. Further, by setting the predetermined threshold value, the embodiments of the invention can further detect whether the length of trace pattern exceeds the threshold value to determine whether the unlocking operation is completed, thereby preventing intruders from attempting to endlessly draw the trace pattern to unlock the locked screen, and thereby enhancing safety.

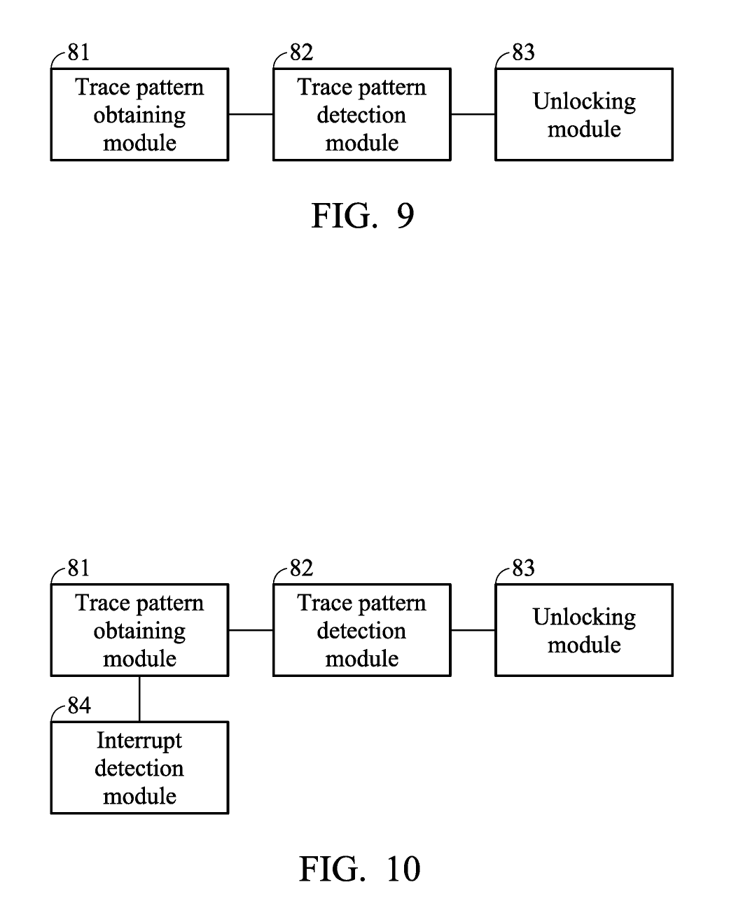

FIG. 9 is a block diagram of an electronic device according to the first embodiment of the present invention. Referring to FIG. 9, the electronic device of this embodiment is described on the basis of the screen unlocking method disclosed by the first embodiment. As shown in FIG. 9, the electronic device of this embodiment comprises a trace pattern obtaining module 81, a trace pattern detection module 82 and an unlocking module 83, wherein the trace pattern obtaining module 81 is coupled with the trace pattern detection module 82 and the trace pattern detection module 82 is coupled with the unlocking module 83.

Before the user performs the screen unlocking operation to unlock the screen on the electronic device, the electronic device is in a sleep or standby mode. The user may enable the electronic device to display a screen unlocking interface on a locked screen of the electronic device by pressing the power button or any function button capable of triggering an unlock operation. In other embodiments of the present invention, the user can also wake up the electronic device by clicking on the screen.

The trace pattern obtaining module 81 is configured to obtain a trace pattern generated by continuously sliding on the locked screen. The trace pattern detection module 82 is configured to detect whether the trace pattern contains at least one predetermined valid trace pattern. That is, the trace pattern detection module 82 is configured to detect whether the trace pattern 1 contains the predetermined valid trace pattern 2.

The unlocking module 83 is configured to unlock the locked screen when the trace pattern detection module 82 detects that the trace pattern contains at least one predetermined valid trace pattern. For example, in this embodiment, the trace pattern detection module 82 detects that the trace pattern 1 (a-e-i-f-a-b-d-h-c) contains the predetermined valid trace pattern 2 (b-d-h-c), so that the unlocking module 83 unlocks the locked screen, wherein the trace pattern at least comprises random invalid trace pattern.

When the trace pattern detection module 82 detects that the trace pattern does not contain at least one predetermined valid trace pattern, the electronic device keeps locking the screen. For example, when the trace pattern generated by continuously sliding on the locked screen is a-e-i-f-a-b-d-h-i-f-c-f, and the trace pattern detection module 82 detects that the trace pattern does not contain the predetermined valid trace pattern2, the electronic device keeps locking the screen.

The present invention also provides a second embodiment of the electronic device, which is described on the basis of the first embodiment of the disclosed electronic device. FIG. 10 is a block diagram of an electronic device according to the second embodiment of the present invention. As shown in FIG. 10, the electronic device of this embodiment further comprises an interrupt detection module 84, wherein the interrupt detection module 84 is coupled with the trace pattern obtaining module 81. The interrupt detection module 84 is configured to determine whether a continuous time for which the trace pattern has been interrupted is less than a predetermined time value when detects the trace pattern is interrupted. When the interrupt detection module 84 detects the trace pattern is interrupted, that is, when the interrupt detection module 84 detects that an interrupt occurs during the continuous sliding operation on the locked screen, the electronic device counts the continuous time for which the trace pattern has been interrupted. The interrupt detection module 84 regards the trace pattern and a trace pattern following the interrupt as a continuous trace pattern when determining that the continuous time for which the trace pattern has been interrupted is less than the predetermined time value.

If the continuous time for which the trace pattern has been interrupted is greater than or equal to the predetermined time value, the interrupt detection module 84 determines that this sliding operation is ended, thereby directly accessing the trace pattern before the interrupt to be the generating trace pattern for this unlocking operation.

It should be noted that, the predetermined time value is preferably to be 1 s (second). The predetermined time value may be set on the electronic devices by the user or it may be set at the factory.

The embodiment may further comprise: the at least one segment of predetermined valid trace pattern may further comprise at least two or more predetermined valid trace patterns, and the trace pattern detection module 82 detects whether the trace pattern contains at least one predetermined valid trace pattern may further comprise the step of detecting whether the trace pattern sequentially contains the at least two or more predetermined valid trace patterns according to a predetermined order.

When the trace pattern detection module 82 detects that the trace pattern sequentially contains the at least two or more predetermined valid trace patterns according to the predetermined order, the unlocking module 83 unlocks the locked screen. In other words, when the trace pattern detection module 82 detects that the trace pattern first contains the predetermined valid trace pattern 3 and then contains the predetermined valid trace pattern 4, the unlocking module 83 unlocks the locked screen.

When the trace pattern detection module 82 detects that the trace pattern does not sequentially contain the at least two or more predetermined valid trace patterns according to the predetermined order, the electronic device keeps the screen being locked. That is, when the trace pattern detection module 82 detects that the trace pattern does not sequentially contain the predetermined valid trace pattern 3 and the predetermined valid trace pattern 4, the electronic device keeps locking the screen.

It should be understood that, if there are at least two or more predetermined valid trace patterns, the trace pattern detection module 82 may also unlock the locked screen when detecting that the trace pattern contains any of the predetermined valid trace patterns. In practice applications, the user can perform corresponding settings based on actual requirements.

Further, in this embodiment, the trace pattern detection module 82 may further detect whether the length of the trace pattern exceeds the threshold value. Specifically, when the trace pattern detection module 82 detects that the length of the trace pattern exceeds the threshold value, it determines this unlocking operation is completed, and the electronic device keeps locking the screen. When the trace pattern detection module 82 detects that the length of the trace pattern has not exceeded the threshold value, the trace pattern detection module 82 detects whether the trace pattern contains at least one predetermined valid trace pattern.

The threshold value can be a predetermined number (i.e. the number of predetermined valid touch points). The trace pattern detection module 82 detects whether the length of the trace pattern exceeds the threshold value, which means that the trace pattern detection module 82 detects whether or not the number of valid touch points contained in the trace pattern exceeds the predetermined number.

In some embodiments, when the predetermined number can be set as five times of the total number of valid touch points contained in at least one predetermined valid trace pattern as default. For example, the total number of valid touch points contained in trace pattern 2 is 4, and the predetermined number can be set as 20.

In other embodiments, there are three valid trace patterns and the total number of valid touch points contained in the three valid trace patterns are 4, 8, and 7 respectively, the trace pattern detection module 82 obtains the maximum value 8 of the total number of valid touch points from the three valid trace patterns and sets the predetermined number as 40. That is, the predetermined number can be set as five times of the maximum value of the total number of valid touch points contained in each of the predetermined valid trace patterns.

It should be noted that, the above threshold value can be specifically set as multiples of valid touch points or be directly set as a value based on the user's own requirements, and the embodiments of the invention is not to be limited.

The predetermined numbers in this embodiment can prevent intruders from attempting to endlessly draw the trace pattern to unlock the locked screen, thus enhancing safety.

In some embodiments, the trace pattern obtaining module 81, the trace pattern detection module 82, and the unlocking module 83 can be integrated into a CPU (central processing unit). In other words, the functions of the trace pattern obtaining module 81, the trace pattern detection module 82, and the unlocking module 83 can be realized by a CPU. In addition, the functions of the trace pattern obtaining module 81, the trace pattern detection module 82, the unlocking module 83, and the interrupt detection module 84 can be realized by a CPU.

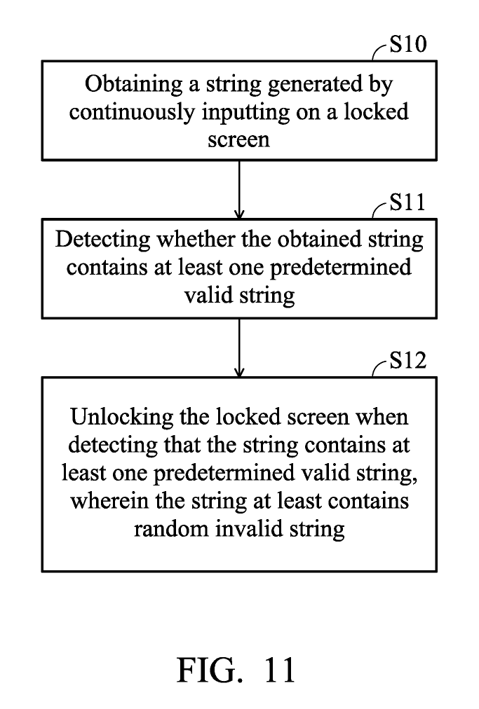

The present invention also provides a third embodiment of the screen unlocking method. The screen unlocking method of the present embodiment can be performed by an electronic device. FIG. 11 is a flowchart of a screen unlocking method according to the third embodiment of the invention. As shown in FIG. 11, the screen unlocking method of this embodiment comprises the steps of:

S10: obtaining a string generated by continuously inputting on a locked screen;

Before step S10, the electronic device is in a sleep or standby mode, and the user may enable the electronic device to display a screen unlocking interface on a locked screen of the electronic device by pressing the power button or any function button capable of triggering an unlocking operation. In other embodiments of the present invention, the user can also wake up the electronic device by clicking on the screen.

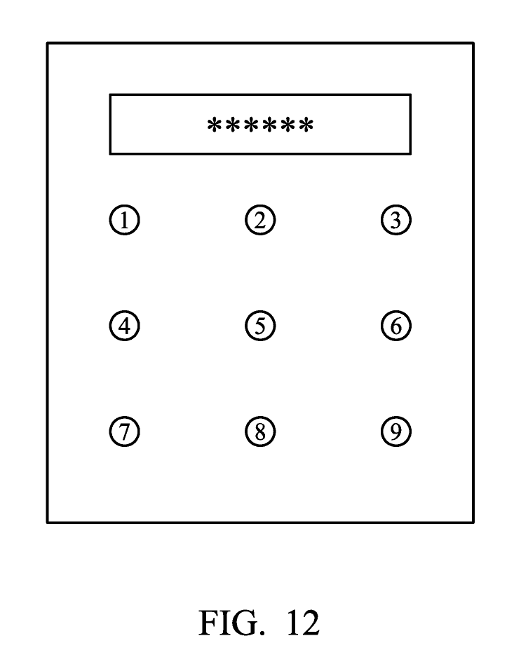

The difference between the screen unlocking method of the first embodiment and that of this embodiment is that a digital password unlocking interface is used as the screen unlocking interface in this embodiment. As shown in FIG. 12, the screen unlocking interface includes an input area and a display area, wherein the input area includes the characters 1, 2, 3, 4, 5, 6, 7, 8, and 9, and the display area is configured to display the string generated by the user continuously inputting. The user may continuously input the string on the input area, such as a user-inputted string 1 of 4-1-5-9-6-2. The electronic device receives the string 1 generated by continuously inputting on the locked screen by the user.

S11: detecting whether the obtained string contains at least one predetermined valid string;

User may set at least one unlocking password for screen unlocking through a password setting function provided by the electronic device. Each predetermined unlocking password contains a valid string.

Taking the user presets a valid string 2 in below as an example. The user's predetermined valid string 2 is set to be 5-9-6-2. In this step, the electronic device detects if the string 1 obtained in step S10 contains the predetermined valid string 2.

S12: unlocking the locked screen when detecting that the string contains at least one predetermined valid string, wherein the string contains at least random invalid string.

When the electronic device detects that the string contains at least one predetermined valid string, the electronic device unlocks the locked screen. For example, in this embodiment, the electronic device detects that the string 1 (4-1-5-9-6-2) contains the predetermined valid string 2 (5-9-6-2) and thus it unlocks the locked screen. Specifically, in this embodiment, the string 1 contains the valid string 2 and a random invalid string (also referred to as pseudo random unlocking string), wherein the pseudo random unlocking string is 4-1. Additionally, every time the user performs the screen unlocking operation, the pseudo random unlocking string contained in the string does not have to be the same. For example, the string generated from the user's continuously inputting on the locked screen can be 1-2-3-5-9-6-2, of which the pseudo random unlocking string is 1-2-3. Therefore, it is difficult for the viewer to crack the lock through learning, thus enhancing safety.

In addition, when an incorrect operation appears during which the user continuously inputs the string on the locked screen, the user can still achieve unlocking by continuously inputting stings on the screen. For example, when the sting 1-4-7 generated by the user's continuously input on the locked screen is an incorrect operation, the user can continuously input the string 5-9-6-2 on the screen to achieve unlocking, thereby effectively reducing incorrect operation of the user during unlocking and improving user's experience.

When the electronic device detects that the string does not contain at least one predetermined valid string, the electronic device keeps locking the screen. For example, when the string generated by the user's continuously inputting on the locked screen is 1-2-3-5-6-9-6-2, and the electronic device detects that the string does not contain the predetermined valid string 2, it will keeps locking the screen.

The embodiments of the present invention can detect whether the string contains at least one predetermined valid string after obtaining the string generated in response to continuously inputting on the locked screen and unlock the locked screen as long as the string is detected as containing at least one predetermined valid string. This will make it difficult for the intruder to crack the lock through viewing and learning, thus enhancing safety, effectively reducing the number of user unlocking errors, and improving user's experience.

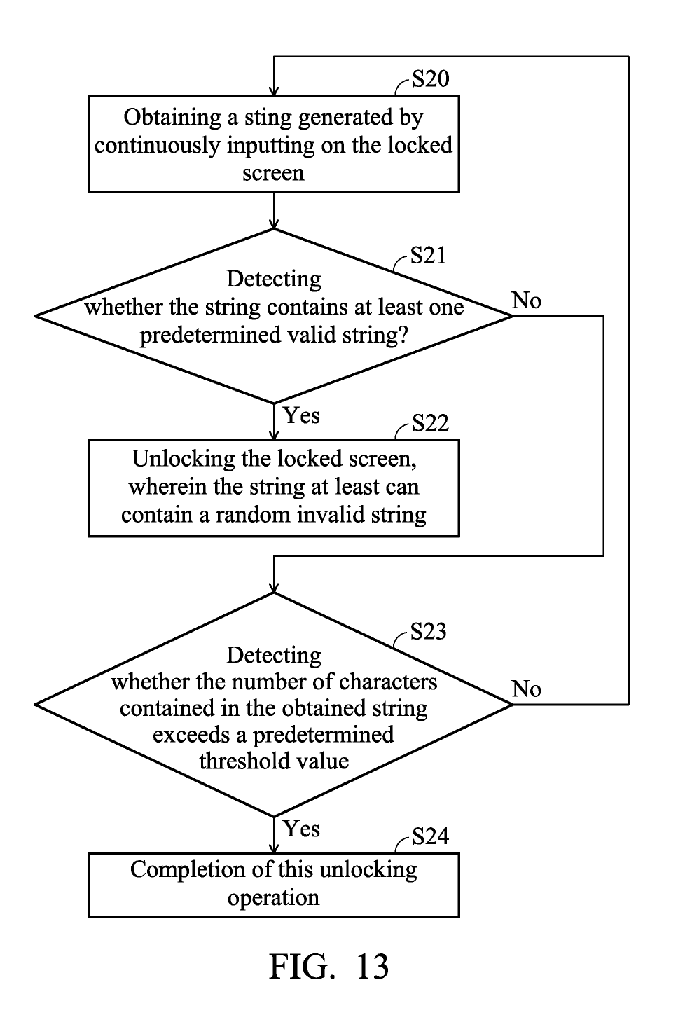

The present invention also provides a fourth embodiment of the screen unlocking method, which is described on the basis of the third embodiment of the screen unlocking method disclosed. As shown in FIG. 13, the screen unlocking method of this embodiment comprises the steps of:

S20: obtaining a sting generated by continuously inputting on the locked screen;

S21, detecting whether the string contains at least one predetermined valid string; if so, the flow goes to step S22, if otherwise, goes to step S23;

S22, unlocking the locked screen, wherein the string at least can contain a random invalid string;

In this embodiment, in step 21, the at least one predetermined valid string may further comprise at least two or more predetermined valid strings, and detection of whether the string contains at least one predetermined valid string may further comprise the step of the electronic device detecting whether the string sequentially contains the at least two or more predetermined valid strings according to a predetermined order.

When the user sets at least two or more predetermined valid stings, the user may sequentially set two valid strings: the valid string 3 and the valid string 4, wherein the predetermined valid string 3 is 2-5-9, the predetermined valid string 4 is 4-8-6-2, and the predetermined order for these two predetermined valid strings are: the predetermined valid string 3 being prior to the predetermined valid string pattern 4.

In step S21, when the electronic device detects that the string sequentially contains the at least two or more predetermined valid strings according to the predetermined order, step S22 is performed to enable the electronic device to unlock the locked screen. For example, when the electronic device detects that the string first contains the predetermined valid string 3 and then contains the predetermined valid string 4, it unlocks the locked screen.

For example, it is assumed that a sting 5 generated by the user's continuously inputting on the locked screen is 1-2-5-9-6-3-4-8-6-2. As the string 5 sequentially contains a pseudo random unlocking string (1), the predetermined valid string 3, another pseudo random unlocking string (6-3) and the predetermined valid string 4 (4-8-6-2), so the electronic device unlocks the locked screen.

In other embodiments, when the electronic device detects that the string does not sequentially contain the at least two or more predetermined valid strings according to the predetermined order, step S23 is performed and the electronic device keeps locking the screen. For example, when the electronic device detects that the string does not sequentially contain the predetermined valid string 3 and the predetermined valid string 4, it will keep locking the screen and the flow goes to step S23.

S23, detecting whether the number of characters contained in the obtained string exceeds a predetermined threshold value; if so, the flow jumps to step S24, which means completion of this unlocking operation, and if not, the flow returns to step S20;

Additionally, in this embodiment, the electronic device may further detect whether the number of characters contained in the string exceeds a predetermined threshold value. When the electronic device detects that the number of characters contained in the string exceeds the threshold value, it determines this unlocking operation is completed, and the electronic device keeps locking the screen and the flow jumps to step S24. When the electronic device detects that the number of characters contained in the string has not exceeded the threshold value, the flow returns to step S20.

For example, it is assumed that the predetermined threshold value is 5. When the electronic device detects that the number of characters contained in the string 1 is 6, which exceeds the predetermined number 5, the electronic device determines this unlocking operation is completed and keeps locking the screen.

In another embodiment, it is assumed that the predetermined threshold value is 15. When the electronic device detects that the number of characters contained in the string 1 is 6, which does not exceed the predetermined threshold value, it returns to step S20.

In some embodiments, the predetermined threshold value can be set as five times of the total number of valid characters contained in at least one predetermined valid string.

For example, if the user has preset a valid string 2 and the total number of valid characters contained in the valid string 2 is 4, the predetermined threshold value can be set as 20.

In other embodiments, if the user has preset three valid strings and the total numbers of valid characters contained in the three valid strings are 4, 8, and 7 respectively, the electronic device obtains the maximum value 8 of the total number of valid touch points from the three valid strings, and sets the predetermined threshold value as 40. That is, the predetermined threshold value can be set as five times of the maximum value of the total number of valid characters contained in each of the predetermined valid strings.

It should be noted that the above threshold value can be specifically set as multiples of a valid string or be directly set as a value based on the user's own needs, and the embodiments of the invention is not to be limiting.

It should be understood that, the embodiment of the present invention does not limit the sequence of steps executed. For example, this step of detecting whether the number of characters contained in the string exceeds the predetermined threshold value trace can be performed prior to the step of “detecting whether the string contains at least one predetermined valid string. Changing the sequence of execution will not affect the effect of the embodiments of the present invention in any way.

Step S24, this unlocking operation is completed.

According to the embodiments of the invention, whether at least one predetermined valid string contained in the string can be detected after the string generated in response to continuously inputting on the locked screen has been obtained and as long as the string containing at least one predetermined valid string is detected, the locked screen is unlocked. This will make it difficult for intruders to crack the lock by viewing and learning, thus enhancing safety, effectively reducing the user's unlocking errors, and improving user experience. Further, by setting the predefined threshold value, the embodiments of the invention can prevent intruders from attempting to endlessly input the string to unlock the locked screen, thereby enhancing safety.

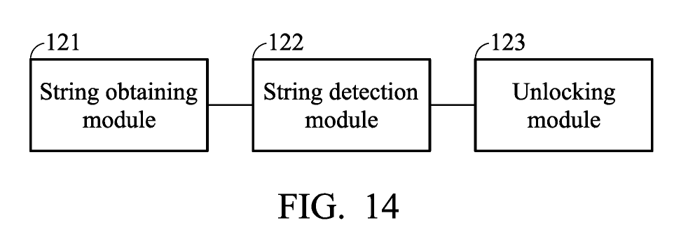

The present invention also provides a third embodiment of the electronic device, which is described on the basis of the screen unlocking method disclosed by the third embodiment. As shown in FIG. 14, in this embodiment, the electronic device comprises a string obtaining module 121, a string detection module 122 and an unlocking module 123, wherein the string obtaining module 121 is coupled with the string detection module 122 and the string detection module 122 is coupled with the unlocking module 123.

Before the user performs the screen unlocking operation to unlock the screen on the electronic device, the electronic device is in a sleep or standby mode. The user may enable the electronic device to display a screen unlocking interface on a locked screen of the electronic device by pressing the power button on the electronic device or any function button capable of triggering an unlock operation. In other embodiments of the present invention, the user can also wake up the electronic device by clicking on the screen.

A digital password unlocking interface is used as the screen unlocking interface in this embodiment. The string obtaining module 121 is configured to obtain a string generated by continuously inputting on a locked screen and the string detection module 122 is configured to detect whether the string contains at least one predetermined valid string.

The user may set at least one unlocking password for screen unlocking through a password setting function provided by the electronic device. Each predetermined unlocking password contains a valid string.

Taking the user presets a valid string 2 in below as an example. The user's predetermined valid string 2 is set to be 5-9-6-2. The string detection module 122 is configured to detect if the string 1 contains the predetermined valid string 2.

The unlocking module 123 is configured to unlock the locked screen when the string detection module 122 detects that the string contains at least one predetermined valid string, wherein the string contains at least random invalid string. For example, in one embodiment, the string detection module 122 detects that the string 1 (4-1-5-9-6-2) contains the predetermined valid string 2 (5-9-6-2) and thus the unlocking module 123 unlocks the locked screen. Specifically, in this embodiment, the string 1 contains the valid string 2 and a pseudo random unlocking string, wherein the pseudo random unlocking string is 4-1. Additionally, every time the user performs the screen unlocking operation, the pseudo random unlocking string contained in the string does not have to be the same. For example, if the string generated from the user's continuously inputting on the locked screen is 1-2-3-5-9-6-2, the string detection module 122 detects that the string contains the predetermined valid string 2 and thus the unlocking module 123 unlocks the locked screen, wherein the pseudo random unlock string of which is 1-2-3. Therefore, it is difficult for the other people to crack the lock through learning, thus enhancing safety.

In addition, when an incorrect operation appears during which the user continuously inputs the string on the locked screen, the user can still achieve unlocking by continuously input stings on the screen. For example, when the sting 1-4-7 generated by the user's continuously inputting on the locked screen is an incorrect operation, the user can continuously input the string 5-9-6-2-6 on the screen to achieve unlocking, thereby effectively reducing incorrect operation of the user during unlocking and improving user's experience.

When the string detection module 122 detects that the string does not contain at least one predetermined valid string, the electronic device keeps locking the screen.

The present invention also provides a fourth embodiment of the electronic device, which is described on the basis of the third embodiment of the disclosed electronic device. In this embodiment, the at least one predetermined valid string may further comprise at least two or more predetermined valid strings, and the string detection module 122 detects whether the string contains at least one predetermined valid string may further comprise the step of the string detection module 122 detecting whether the string sequentially contains the at least two or more predetermined valid strings according to a predetermined order.

When the string detection module 122 detects that the string sequentially contains the at least two or more predetermined valid strings according to the predetermined order, the unlocking module 123 unlocks the locked screen.

When the string detection module 122 detects that the string does not sequentially contain the at least two or more predetermined valid strings according to the predetermined order, the electronic device keeps locking the screen.

In this embodiment, the string detection module 122 may further detect whether the number of characters contained in the string exceeds a predetermined threshold value.

When the string detection module 122 detects that the number of characters contained in the string exceeds the threshold value, it determines this unlocking operation is completed, and the electronic device keeps locking the screen.

When the electronic device detects that the number of characters contained in the string has not exceeded the threshold value, the string obtaining module 121 receives the string generated by continuously inputting on the locked screen and the string detection module 122 detects whether the string contains at least one predetermined valid string.

When the user does not set the predetermined threshold value, the predetermined threshold value can be five times of the total number of valid characters contained in at least one predetermined valid string.

It should be noted that, the above threshold value can be specifically set as multiples of a valid string or be directly set as a value based on the user's own needs, and the embodiments of the invention is not to be limiting.

By setting the predefined threshold value, the embodiments of the invention can prevent intruders from attempting to endlessly input strings to unlock the locked screen, thereby enhancing safety.

In some embodiments, the string obtaining module 121, the string detection module 122, and the unlocking module 123 can be integrated into a CPU (central processing unit). In other words, the functions of the string obtaining module 121, the string detection module 122, and the unlocking module 123 can be realized by a CPU.

In summary, the present invention can receive trace pattern generated by continuously sliding on the locked screen and detect whether trace pattern contains at least one predetermined valid trace pattern. When it is detected that the trace pattern contains at least one predetermined valid trace pattern, the locked screen is unlocked. The trace pattern also contains pseudo random unlocking pattern, but pseudo random unlocking pattern is not the same every time. This will make it difficult for intruders to crack the lock through learning, thus enhancing safety, effectively reducing the user's unlocking errors, and improving user experience.

While the invention has been described by way of example and in terms of preferred embodiment, it is to be understood that the invention is not limited thereto. Those who are skilled in the art can still make various alterations and modifications without departing from the scope and spirit of this invention. Therefore, the scope of the present invention shall be defined and protected by the following claims and their equivalents.

What is claimed is:

1. A screen unlocking method, comprising:
obtaining a trace pattern generated by continuously sliding on a locked screen;
detecting whether the trace pattern contains at least one predetermined valid trace pattern; and
when detecting the at least one predetermined valid trace pattern in the trace pattern, unlocking the locked screen, wherein the trace pattern comprises at least one random invalid trace pattern.

2. The screen unlocking method of claim 1, further comprising:
detecting whether a length of the trace pattern exceeds a predetermined threshold value; and
when detecting that the length of the trace pattern exceeds the predetermined threshold value, determining that the unlocking operation is completed.

3. The screen unlocking method of claim 2, wherein the trace pattern and the predetermined valid trace pattern are formed by connecting a plurality of valid touch points;
wherein the step of detecting whether the length of the trace pattern exceeds the predetermined threshold value further comprises:
detecting whether the number of the valid touch points contained in the trace pattern exceeds a predetermined number.

4. The screen unlocking method of claim 3, wherein the predetermined number is five times of a total number of the valid touch points contained in the at least one predetermined valid trace pattern.

5. The screen unlocking method of claim 1, wherein, when the at least one predetermined valid trace pattern at least comprises two or more predetermined valid trace patterns, the step of detecting whether the trace pattern contains the at least one predetermined valid trace pattern further comprises:
detecting whether the trace pattern sequentially contains the two or more predetermined valid trace patterns in a predetermined order.

6. The screen unlocking method of claim 1, further comprising:
when detecting that the trace pattern has been interrupted, determining whether a time for which the trace pattern has been interrupted is less than a predetermined time value; and
if so, regarding the trace pattern being interrupted as a continuous trace pattern.

7. An electronic device, comprising:
a trace pattern obtaining module, configured to obtain a trace pattern generated by continuously sliding on a locked screen;
a trace pattern detection module, configured to detect whether the trace pattern contains at least one predetermined valid trace pattern; and
an unlocking module, configured to unlock the locked screen when the trace pattern detection module detects the at least one predetermined valid trace pattern in the trace pattern, wherein the trace pattern comprises at least one random invalid trace pattern.

8. The electronic device of claim 7, wherein the trace pattern detection module is further configured to detect whether a length of the trace pattern exceeds a predetermined threshold value, and the trace pattern detection module is further configured to determine that the unlocking operation is completed when detecting that the length of the trace pattern exceeds the predetermined threshold value.

9. The electronic device of claim 8, wherein the trace pattern and the predetermined valid trace pattern are formed by connecting a plurality of valid touch points;
wherein the trace pattern detection module is further configured to detect whether the number of valid touch points contained in the trace pattern exceeds a predetermined number.

10. The electronic device of claim 9, wherein the predetermined number is five times of a total number of the valid touch points contained in the at least one predetermined valid trace pattern.

11. The electronic device of claim 7, wherein, when the at least one predetermined valid trace pattern at least comprises two or more predetermined valid trace patterns, the trace pattern detection module is further configured to detect whether the trace pattern sequentially contains the two or more predetermined valid trace patterns according to a predetermined order.

12. The electronic device of claim 7, further comprising:
an interrupt detection module, configured to determine whether a time for which the trace pattern has been interrupted is less than a predetermined time value when detecting that the trace pattern has been interrupted,
when detecting that the time for which the trace pattern has been interrupted is less than the predetermined time value, the interrupt detection module is further configured to regard the trace pattern being interrupted as a continuous trace pattern.

13. A screen unlocking method, comprising:
obtaining a string generated by continuously inputting on a locked screen;
detecting whether the string contains at least one predetermined valid string; and
when detecting the at least one predetermined valid string in the obtained string, unlocking the locked screen, wherein the obtained string comprises at least one random invalid string.

14. The screen unlocking method of claim 13, further comprising:
detecting whether the number of characters contained in the string exceeds a predetermined threshold value; and
when detecting that the number of characters contained in the string exceeds the predetermined threshold value, determining that the unlocking operation is completed.

15. The screen unlocking method of claim 14, wherein the predetermined threshold value is five times of a total number of the valid characters contained in the at least one predetermined valid string.

16. The screen unlocking method of claim 13, wherein, when the at least one predetermined valid string at least comprises two or more predetermined valid strings, the step of detecting whether the string contains the at least one predetermined valid string further comprises:
detecting whether the string sequentially contains the two or more predetermined valid strings according to a predetermined order.

17. An electronic device, comprising:
a string obtaining module, configured to obtain a string generated by continuously inputting on a locked screen;
a string detection module, configured to detect whether the string contains at least one predetermined valid string; and
an unlocking module, configured to unlock the locked screen when the string detection module detects the at least one predetermined valid string in the string, wherein the string at least comprises at least one random invalid string.

18. The electronic device of claim 17, wherein the string detection module is further configured to detect whether the number of characters contained in the string exceeds a predetermined threshold value; and
when detecting that the number of characters contained in the string exceeds the predetermined threshold value, the string detection module is further configured to determine that the unlocking operation is completed.

19. The electronic device of claim 18, wherein the predetermined threshold value is five times of a total number of the valid characters contained in the at least one predetermined valid string.

20. The electronic device of claim 17, wherein, when the at least one predetermined valid string contains at least two or more predetermined valid strings, the string detection module is further configured to detect whether the string sequentially contains the two or more predetermined valid strings according to a predetermined order.
